(19) United States
(12) Patent Application Publication
(10) Pub. No.: US 2006/0102762 A1
(43) Pub. Date: May 18, 2006

(54) Cutterhead assembly

(76) Inventors: Jaime E. Garcia, Jackson, TN (US); Jeffrey D. Weston, Jackson, TN (US)

Correspondence Address: THE BLACK & DECKER CORPORATION, 701 EAST JOPPA ROAD, TW199, TOWSON, MD, 21286, US

(21) Appl. No.: 10/803,555

(22) Filed: Mar. 17, 2004

Related U.S. Application Data
(60) Provisional application No. 60/455,403, filed on Mar. 17, 2003.

(51) Int. Cl. B02C 18/16

(52) U.S. Cl. 241/294

(57) ABSTRACT

The present invention is directed to a cutterhead including a cylindrical main body portion including a recess for at least partially receiving a knife. A primary shaft extends from an end of the main body portion. Preferably, the primary shaft includes a keyway or flat portion to mechanically connect the shaft to a power tool's drive system. A secondary shaft extends from the opposing end of the main body portion for supporting the cutterhead minimizing vibration and the like. A knife assembly is included in the cutterhead for permitting secure positioning of the knife. A lock bar is included to sandwich the knife between a sidewall of the knife recess and the lock bar. An index pin is disposed so as to engage the knife and lock bar. So as to generally fix the knife to the lock bar. In additional embodiments, the knife's position along a primary axis of the main body portion may be varied to extend the knife's cutting life. A height adjustment screw extends through a threaded aperture in the lock bar to allow for height adjustment of the lock bar/knife from above the lock bar. A securing screw extends through the cylindrical outer surface of the main body portion so as to secure the lock bar/knife against a sidewall of the knife recess included in the main body portion.

### CROSS REFERENCE

The present application claims priority under 35 U.S.C. §119(e) to U.S. Provisional Patent Application Ser. No. 60/455,403, entitled: Cutterhead Assembly, filed on Mar. 17, 2003, which is hereby incorporated by reference in its entirety.

### FIELD OF THE INVENTION

The present invention relates to the field of woodworking and particularly to a cutterhead assembly for a joiner.

### BACKGROUND OF THE INVENTION

A joiner is a critical component to any good workshop. Joiners typically include knives which are rotated to remove material between off-set surfaces. For example the rotating knives may be mounted between a first table at a first height and a second table at a second height. This off-set with corresponding material removal allows a user to “true-up” a workpiece or create an edge which is flat (typically the trued side is additionally squared to a second adjacent side to form a uniform shape for subsequent operations). While stationary joiners are prevalent, hand held joiners are gaining popularity as woodworkers move between worksites or utilize the shaping capability in new ways (such as for on-site timber framing). For example, hardwood lumber is typically retailed in an imperfect state. In this situation, the end consumer is required to remove imperfections such as bows in the workpiece, imperfections from sawing operations such as from a rip cut, or rough edges before proceeding.

When utilizing salvaged materials (e.g., barn boards) metal within the workpiece such as nails, may damage the joiner's knives. As a result, a user may be left with a knife (or knives) which systematically leave a ridge longitudinally down the workpiece. To correct this problem a user is either forced to replace the knife (or knives) or sand out this imperfection. A drawback to a typical joiner is the relative complexity of replacing the knives. For example, if one knife was damaged the user may be forced to remove an additional knife to effectuate the repair. Further, because of a joiner's precision, a user may be force to conduct a time consuming blade replacement which detracts from the overall user experience with the tool. Typically, proper knife alignment may require a high level of user sophistication, knowledge, and dexterity.

Therefore, it would be desirable to provide a cutterhead for a joiner configured for easy, quick knife replacement or positioning.

### SUMMARY OF THE INVENTION

Accordingly, the present invention is directed generally to a cutterhead capable of efficient knife replacement and positioning.

In an aspect of the present invention, a cutterhead includes a cylindrical main body portion including a recess for at least partially receiving a knife. A primary shaft extends from an end of the main body portion. Preferably, the primary shaft includes a keyway or flat portion to mechanically connect the shaft to a power tool's drive system. A secondary shaft extends from the opposing end of the main body portion for supporting the cutterhead minimizing vibration and the like. A knife assembly is included in the cutterhead for permitting secure positioning of the knife. A lock bar is included to sandwich the knife between a sidewall of the knife recess and the lock bar. An index pin is disposed so as to engage the knife and lock bar. So as to generally fix the knife to the lock bar. In additional embodiments, the knife's position along a primary axis of the main body portion may be varied to extend the knife's cutting life. A height adjustment screw extends through a threaded aperture in the lock bar to allow for height adjustment of the lock bar/knife from above the lock bar. A securing screw extends through the cylindrical outer surface of the main body portion so as to secure the lock bar/knife against a sidewall of the knife recess included in the main body portion.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an exploded view of a cutterhead assembly including an adjustable knife in accordance with an embodiment of the invention;

FIG. 2 is a cross-sectional view of a cutterhead assembly taken along line 2-2 of FIG. 4;

FIG. 3 is an enlarged view of FIG. 2; and

FIG. 4 is a perspective view of a cutterhead assembly.

### DETAILED DESCRIPTION OF THE INVENTION

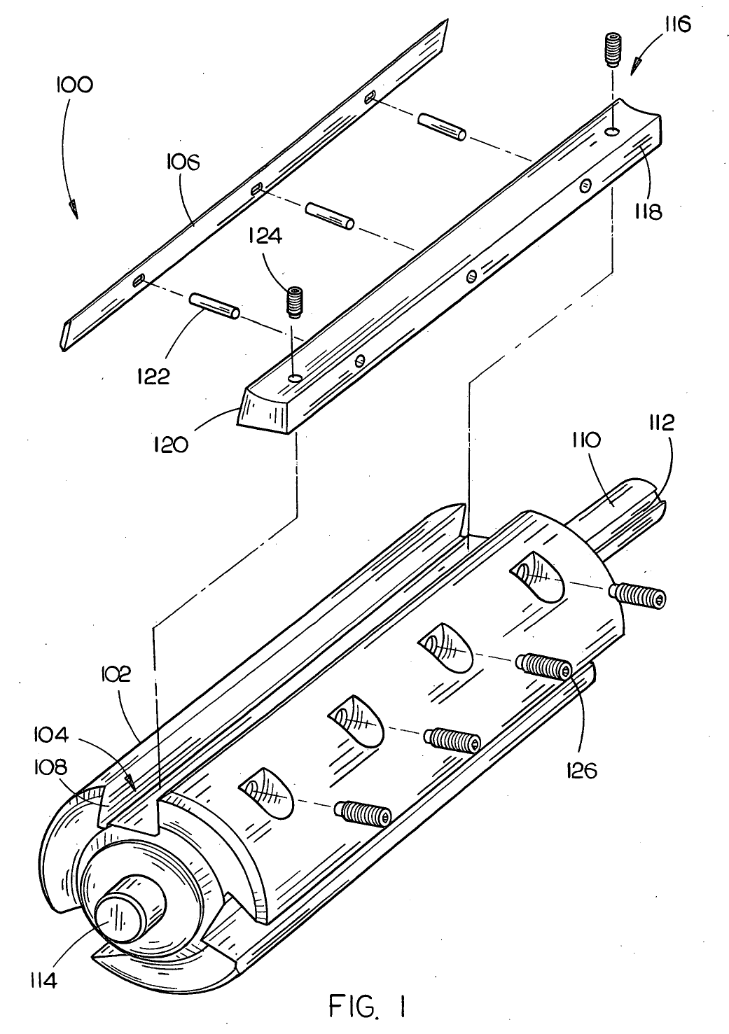

Referring now to FIGS. 1 through 4, a cutterhead 100 in accordance with an exemplary embodiment of the present invention is discussed. A cutterhead 100 of the present invention may be implemented in fixed (stationary) jointers, a portable hand joiners, shapers (such as for forming molding), and the like. The cutterhead 100 allows for rapid knife blade replacement and easy knife alignment. For example, a cutterhead in accordance with the present invention permits a user to replace a single knife blade without requiring readjustment of an adjacent knife blade. Further, the cutterhead of the present invention permits knife height adjustment from above a lock bar (radially outward from the lock bar), such as when the cutter head is implemented in a stationary joiner, or when a portable joiner is inverted for knife changing or repositioning.

In an exemplary embodiment, the cutterhead 100 includes a generally cylindrical main body portion 102. For example, a main body portion may be constructed for utilization in a 6″ (six inch) joiner or an 8″ (eight inch) joiner. Additionally, the cutterhead of the embodiment may allow for retrofitting into existing joiners, shapers and the like. For instance, a drive gear or chain sprocket may be included on or mounted to the cutterhead for rotating the cutterhead.

The main body 102 includes at least one, but preferably a series of knife recesses 104 for receiving a knife assembly 116 including a knife 106. When multiple knives are utilized, the knife recesses/knives are positioned in order to balance the cutterhead 100. For example, if three knives are implemented, the knives are generally off-set at 120° (one hundred twenty degrees) to minimize vibration, provide a smooth finish and the like. A knife recess 104 is a pocket or trough extending longitudinally along the main body portion 102. In a first embodiment, a knife recess is formed as a generally rectilinear trough between a first end and a second end of a main body portion. In a further aspect of the invention, a secondary recess is included in the floor (the side of the trough adjacent a primary axis of the main body portion). For instance, a secondary recess or stepped portion may be included to allow for a double bladed (or edged) knife. A doubled edged knife allows a user to invert or “flip over” the knife blade should an edge become unusable due to damage or the like. Preferably, a knife is disposable thereby avoiding the need for sharpening. In further examples, a blade is constructed to be re-sharpened as desired.

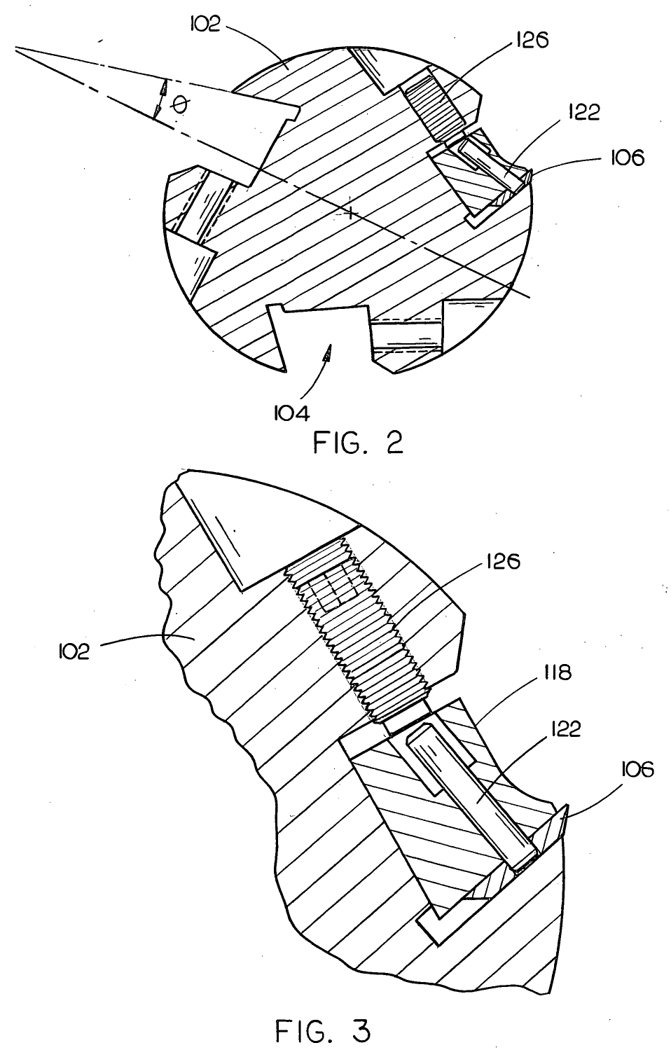

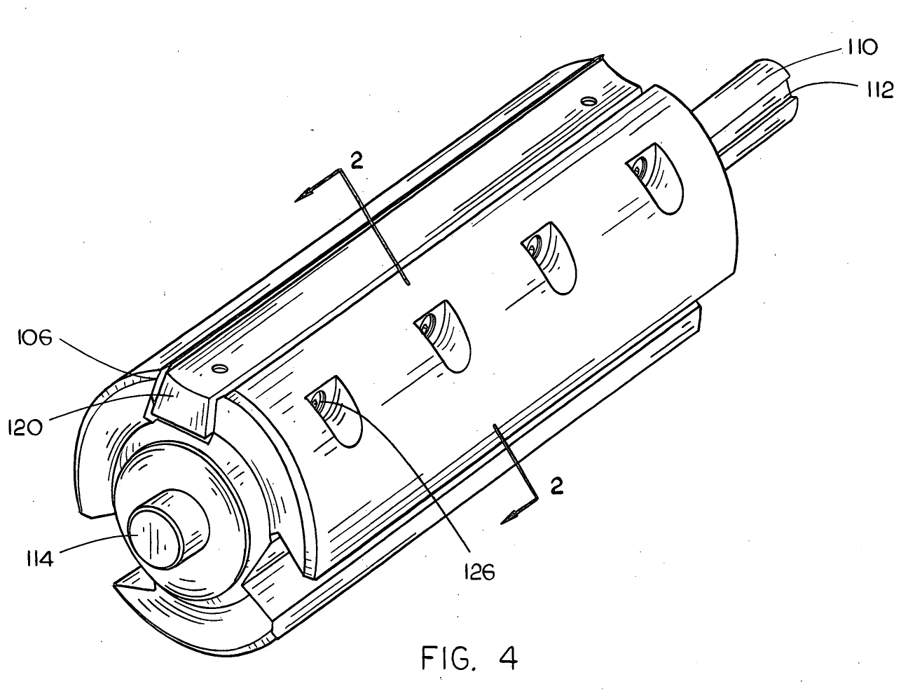

As may be best seen in FIGS. 2 and 3, preferably, a sidewall, formed in the main body portion 102, of the knife recesses is angled so as to hold a received knife/knife assembly at a desired orientation for material removal. A side of the knife recess is angled (i.e., an angled sidewall 108), thus the side is not perpendicular to a chord formed by connecting the outer most points of the side walls forming the recess, when viewed in cross-section. Alternatively, the angle may be expressed by extending an axis or line through the front surface of the angled sidewall and a diameter or axis or line extending through the diameter of the main body portion 102. For example, the exact angular orientation of the knife θ (theta) is optimized based on the type of material to be removed. The angular orientation is selected based on material's hardness such as hardwoods, like oak, maple, walnut verses soft woods such as pine. In additional embodiments, the angular position is an intermediate orientation to allow the user to implement the device for the widest range of materials. Preferably, the knife is angled at between 25°-35° (twenty-five degrees to thirty-five degrees) or at between 27°-34° (twenty-seven degrees to thirty-four degrees) depending on workpiece material and the like.

Referring to FIGS. 1 and 4, a primary shaft 110 extends from an end of the main body portion 102 along the primary axis of the cutterhead 100. Preferably, the primary shaft 110 includes a flattened portion, an alignment aperture, a mechanical interlock, or the like for securing the cutterhead to a drive mechanism. For example, a keyway 112 is included on the primary shaft 110 for fixing the primary shaft to the power tool's drive mechanism such as a pocket for receiving the primary axis 110 in a stationary joiner. A secondary shaft 114 may extend form the opposite end of the main body for maintaining alignment of the cutterhead during use, minimizing vibration, maintain alignment, and the like. For example, the secondary shaft 114 is received in a pocket or recess, a support bracket having an aperture, to maintain alignment of the cutterhead 100 with respect to two off-set support surfaces when implemented in a joiner.

A knife assembly 116 includes a lock bar for securing the removable knife 106 in the knife recess 104, such as by sandwiching the knife 106 against the angled sidewall 108 of the recess. A lock bar 118 is substantially rectangular. In additional embodiments, a side 120 of the lock bar 118 is angled to correspond to the angled sidewall 108 of the knife recess. Thus, the knife may be sandwiched or secured between the angled sidewall 108 of the knife recess and the angled side of the lock bar. Preferably, the lock bar and knife recess are dimensioned so that a user may remove the knife and/or lock bar without having to pull the lock bar out in the direction of a primary axis of the cutterhead. Thus, when implemented with a stationary joiner the lock bar may be efficiently removed from above the cutterhead (though a slot included between off-set support surfaces).

Referring to FIG. 1, an index pin 122 is included to align or generally fix the knife 106 with respect to the lock bar 118. For example, an index pin is utilized to interconnect the knife/lock bar such that the height adjustment of the lock bar raises/lowers the knife, with respect to the outer cylindrical surface of the main body portion 102. In addition, the index pins may aid in maintaining proper alignment as centripetal force acts on the knife when the cutterhead is rotated. Preferably, at least two index pins extend between the lock bar and the knife so align the knife. Preferably, at least one of the knife and lock bar includes an aperture which is elongated (e.g., oval, a through channel, a key hole shaped to accept an index pin with an enlarged head, or the like) in shape such that the position of the knife may be adjusted. (Those of skill in the art will appreciate that the lock bar may be formed with a similar structure to accomplish substantially the same purpose.) For example, if a knife is nicked by a nail or other hard object the knife may be adjusted along the length of the cutterhead (e.g., a primary axis of the main body portion) so that corresponding nicks in other knives may be misaligned to allow for longer cutting life. Preferably, for ease of manufacture, an elongated aperture is formed in the knife, such as to allow approximately a one-eighth of an inch offset (⅛″). A ⅛″ offset may be sufficient for most typically encountered nicks. In the present embodiment, the index pin is received in a recess included in the lock bar (such that the index pin may be removed). In further examples, an index pin may be unitary with the lock bar or secured to the lock bar (e.g. threaded into engagement with the lock bar) to prevent loss or the like.

With continued reference to FIG. 1, in the current embodiment, the knife assembly 116 includes a height adjustment screw 124, such as a set screw, for aligning the height of the lock bar/knife. Those of skill in the art will appreciate that various threaded structures may be utilized which are to be considered as “screws”. It is the intention of this application to encompass and included these structures throughout this application. Preferably, at least two height adjustment screws are utilized in order to adjust the height evenly along the lock bar/knife. For example, to extend or retract the height of the knife 106 beyond the outer cylindrical surface of the main body 102. Preferably, by utilizing a height adjustment screw which is threaded through the lock bar a user does not have to re-adjust the height every time a knife is changed. For example, a user may remove the knife without having to remove or adjust the height adjustment screw. Moreover, by utilizing a screw height adjustment system the user may not have to recalibrate adjacent knives (such as if two knives are secured via a single mechanism) to the cutterhead, if only one knife is changed. Those of skill in the art will appreciate that additional height adjustment screws may be needed if a longer cutterhead is desired, such as to minimize height variation due to centripetal force, force exerted by the interaction of the workpiece and knife, knife deformation, or the like. Usually, two height adjustment screws typically are sufficient for a 6-8″ (inch) cutter head, such as is used on a joiner. Preferably, the height adjustment screws 124 are sufficiently separated to support the knife as well as permit easy height adjustment. By disposing the height adjustment system through the lock bar permits easy adjustment from above the lock bar rather than having the screws supporting the knife itself. For example, if a cutterhead is utilized in a stationary joiner the user may access the height adjustment screws in an efficient manner.

Referring now to FIGS. 1 and 3, a securing screw 126 (preferably at least two securing screws are utilized) is included in the knife assembly 116 to secure the lock bar/knife at least partially in the knife recess 104 included in the main body 102. In the current embodiment, a series of screws are threaded through the cutterhead (opposite the angled sidewall 108) to engage (press against) the lock bar, thus securing the knife/knife assembly to the cutterhead. In the present example, the securing screws drive the lock bar against the angled sidewall of the recess. This securing system allows the knife assembly to be efficiently secured/unsecured and permits height adjustment. In alternative embodiments, a least a portion of the screw is received in an aperture or recess included in the lock bar. Those of skill in the art will appreciate that various securing systems may be utilized without departing from the scope and spirit of the present invention. Moreover, the angled side of the knife recess may be directed so that rotation of the cutterhead forces the knife against the angled portion of the recess (such as via centripetal force), to hold the knife firmly while removing material.

It is believed that the apparatus of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A cutterhead, comprising:
a cylindrical main body portion, having a cylindrical outer surface, including a knife recess for receiving a knife therein, said knife recess forming a channel extending along the main body portion, said recess having an angled sidewall;
a primary shaft extending from a first end of the main body portion;
a secondary shaft extending from a second end of the main body portion, generally opposite the primary shaft; and
a knife assembly including:
a lock bar configured to be received in the knife recess, the lock bar including an angled side arranged to sandwich the knife between the angled sidewall and the lock bar;
an index pin for generally fixing the knife relative to the lock bar;
a height adjustment screw threading with a corresponding threaded aperture included in the lock bar to adjust the height of the lock bar with respect to the outer cylindrical surface of the main body portion; and
a securing screw, for securing the lock bar to the main body, with a threaded aperture extending through said cylindrical outer surface of the main body portion to a side of the recess generally opposite the angled sidewall,
wherein the knife assembly permits access to the height adjustment screw from above the lock bar when the knife assembly is received in the knife recess.

2. The cutterhead of claim 1, wherein the securing screw extends at least partially into the lock bar.

3. The cutterhead of claim 1, wherein the lock bar includes an aperture for receiving the index pin.

4. The cutterhead of claim 1, wherein the index pin is fixed to the lock bar.

5. The cutterhead of claim 1, wherein the angled sidewall of the knife recess is angled in the range of between 25° (twenty-five degrees) to 35° (thirty-five degrees from an extended diameter line and a line extending through the angled sidewall.

6. The cutterhead of claim 1, wherein the angled sidewall of the knife recess is angled in the range of between 27° (twenty-seven degrees) to 34° (thirty-four degrees from an extended diameter line and a line extending through the angled sidewall.

7. The cutterhead of claim 1, further comprising a spring disposed in the knife recess between the knife and a bottom wall of the knife recess.

8. The cutterhead of claim 1, wherein the cutterhead is configured to accept three knives.

9. The cutterhead of claim 1, wherein the primary shaft includes means for securing the shaft.

10. The cutterhead of claim 9, wherein the securing means is a flattened portion, an alignment aperture, or a mechanical interlock.

11. The cutterhead of claim 1, wherein the knife recess is configured to accept a double headed knife.

12. The cutterhead of claim 1, wherein the cutterhead is configured for utilization with a joiner.

13. A cutterhead, comprising:
a cylindrical main body portion, having a cylindrical outer surface, including a knife recess, said knife recess forming a channel extending along the main body portion, said recess having an angled sidewall;
a primary shaft extending from a first end of the main body portion;
a secondary shaft extending from a second end of the main body portion, generally opposite the primary shaft; and
a knife assembly including:
a knife extending generally along the main body portion, the knife including a knife aperture therein;
a lock bar configured to be received in the knife recess, the lock bar including an angled side arranged to sandwich the knife between the angled sidewall and the lock bar;
an index pin for being received in the knife aperture fixing the knife relative to the lock bar;
a height adjustment screw threading with a corresponding threaded aperture included in the lock bar to adjust the height of the lock bar with respect to the outer cylindrical surface of the main body portion; and
a securing screw, for securing the lock bar to the main body, with a threaded aperture extending through said cylindrical outer surface of the main body portion to a side of the recess generally opposite the angled sidewall,
wherein the knife aperture is elongated along a primary axis of the knife to allow for adjustable positioning of the knife with respect to the main body.

14. The cutterhead of claim 13, wherein the securing screw extends at least partially into the lock bar.

15. The cutterhead of claim 13, wherein the lock bar includes an aperture for receiving the index pin.

16. The cutterhead of claim 13, wherein the index pin is fixed to the lock bar.

17. The cutterhead of claim 13, wherein the cutterhead is configured to accept three knives.

18. The cutterhead of claim 13, wherein the primary shaft includes means for securing the shaft.

19. The cutterhead of claim 18 wherein the securing means is a flattened portion, an alignment aperture, or a mechanical interlock.

20. The cutterhead of claim 13, wherein the knife recess is configured to allow for approximately a ⅛″ (one-eighth inch) adjustment.

21. A cutterhead, comprising:
a cylindrical main body portion, having a cylindrical outer surface, including a knife recess for receiving a knife therein, said knife recess forming a channel extending along the main body portion;
a primary shaft extending from a first end of the main body portion;
a secondary shaft extending from a second end of the main body portion, generally opposite the primary shaft; and
means for securing the knife in a desired orientation in the knife recess,
wherein the cutterhead is configured to allow for adjustable positioning of the knife, generally along a primary axis of the main body portion.

22. The cutterhead of claim 21, wherein the primary shaft includes means for securing the shaft.

23. The cutterhead of claim 22 wherein the securing means is a flattened portion, an alignment aperture, or a mechanical interlock.

24. The cutterhead of claim 21, wherein the securing means is constructed to allow for approximately a ⅛″ (one-eighth inch) adjustment.
